(19) United States
(12) Patent Application Publication
(10) Pub. No.: US 2012/0290309 A1
(43) Pub. Date: Nov. 15, 2012

(54) Military Relocation Facilitator

(76) Inventor: Phillip Peacock Bakke, San Antonio, TX (US)

(21) Appl. No.: 13/341,214

(22) Filed: Dec. 30, 2011

Related U.S. Application Data
(60) Provisional application No. 61/486,149, filed on May 13, 2011.
(60) Provisional application No. 61/489,151, filed on May 23, 2011.
(60) Provisional application No. 61/542,621, filed on Oct. 3, 2011.

(51) Int. Cl. G06Q 10/00

(52) U.S. Cl. 705/1.1

(57) ABSTRACT

A facility, system and related business methods for providing efficient, simple, and effective military relocation tools both at the departing station as well as the gaining station of relocating military personnel, centered on an enabling facility based on a department store model where clients are able to access a variety of military relocation services in one location. The business method and system of the present invention alleviates the stress of going all over town, standing in long lines, and wasting time and money trying to get setup in a new home. As a result, embodiments of the present invention help transform the complex, emotional and lengthy process of relocation into a simple, comforting and, most importantly, human process for the relocating military families that are served—all at no cost to the relocating military personnel.

### CLAIM OF PRIORITY TO PRIOR APPLICATIONS

Under 35 U.S.C. 119 and 120, to the extent applicable, this application claims the benefit of the filing date of U.S. Provisional Application Ser. Nos. 61/486,149, filed on May 13, 2011, entitled “Method and System for Facilitating Military Personnel Relocation;” 61/489,151, filed on May 23, 2011, entitled “Military Personnel Relocation Facilitator;” and 61/542,621, filed on Oct. 3, 2011, entitled “Military Personnel Relocation Facilitator;” the entire contents of which are incorporated herein by this reference.

### STATEMENT REGARDING FEDERALLY FUNDED RESEARCH AND DEVELOPMENT

The inventions described and claimed in this patent application were not the subject of federally sponsored research or development.

### FIELD OF THE INVENTIONS

The present inventions relate to the field of military personnel relocation and, more particularly, to systems and methods for facilitating the relocation of military personnel and their families through the structured provision of relocation services.

### ADDITIONAL BACKGROUND

Even in peacetime, military personnel and their families are required to make tremendous life sacrifices for their country. Much of such life sacrifices revolve around the reality that they will go and live where and when they are ordered, such that military families are required to relocate seemingly more than any other sizable segment of society, and to take it in stride.

Moves (or “relocations”) for a military family are often initiated through military relocation orders such as Permanent Change of Station (“PCS”), Temporary Change of Station (“TCS”), or Temporary Duty (“TDY”) orders (amongst others), and they typically occur numerous times during a military career. Such moves are rarely easy, and usually very stressful. A typical drill goes something like this: pack up your entire lives in boxes, load up the kids and pets in the car, say good-bye to your closest friends, head out to your new duty station, and pray that what you learned over the Internet is, in fact, what your new community is really like. Then, the hard part begins.

Finding just the right house to call home in the new community is only a part of the process. The family also faces a daunting list of secondary but critical tasks such as forwarding mail and securing new utilities, new bank accounts, new schools, new jobs and—essentially—a new life for the entire family. These tasks oftentimes must be done remotely and in between normal military life, if there is such a thing. Add to that the additional worry of almost certain deployment for the service member, and the stress can be overwhelming. You end up with a pressure cooker of a situation.

Needless to say, any move from one community to another can be a monumental life change, particularly for families with school-age children. Not only is it naturally difficult to feel at home at a new station, but the disconnect feels all the more dramatic and military relocations are all the more difficult, emotional and energy-draining due to the stressful and unpredictable nature of typical military life.

The gravity of the challenges are also evident just from the sheer numbers. In the U.S., there are roughly 1.4 million active duty members in all branches of the military, and over the course of a 20 year military career they can each expect to move seven to ten times. That averages to a move every 3 to 4 years and also means 350,000 to 450,000 service members are moving every year in the U.S. military. Because of the exceptional burden on such large numbers of people who already sacrifice so much, various laws and benefit programs have been established to favor military family relocation.

Naturally, the military itself has a substantial incentive to address such needs. Military bases, therefore, routinely have their own Housing Offices and/or other types of relocation assistance offices that are staffed with personnel familiar with the government assistance programs and the typical military process for accomplishing and funding aspects of a relocation. Though military housing offices typically have approval authority over the military service member, they are usually a Godsend for the relocating service member and/or family, even though the help provided tends to emphasize services available through military funded programs. Despite the known routines of such military housing offices, they tend to have limited and/or inefficient access to service providers that are based in the community that surrounds or otherwise lies outside the perimeters of the military base (for reference, “community-based service providers”).

Prior efforts have generally had limited success, and some tended to provide more support and be more accessible on the departure end of a military relocation, while still leaving limited resources available to support the families in their destination communities at the gaining end of relocation. The Department of Defense (the “DoD”), for instance, reportedly has helped organize civilian businesses to help military personnel leave their station of origin when reassigned, which improves the situation on the sending end, although the contrast can inadvertently compound the sense of disconnection at the receiving (or “gaining”) end of the military relocation. Additionally, even when businesses and military operations attempt to meet the gaining end needs of relocating military personnel, such efforts are of limited scope, highly cost-constrained, and tend to be plagued with inefficiency and procedural red tape.

From the opposite side, efforts have been made to help military service members access community-based service providers on the gaining end of a military relocation, but such efforts also tend to have a limited focus, although perhaps for different reasons. Available community-based relocation services tend to have limited if not solitary focus on providing a particular type of service without addressing the full spectrum of needs. Other offerings, for instance, have reportedly attempted to provide personal advisors to coordinate a variety of realty-focused services such as real estate agent selection, home buying assistance, home sale assistance, mortgage coordination, home inspection, title insurance, and closing services. Presumably driven by business motives, the assortment of services tend to hub around the real estate focus of such a business. Likewise, where offerings are developed by other particular types of community-based service providers, the solutions tend to favor provision of their particular type of services, while any ancillary offerings are not provided in a way that is helpful enough for the service member. Consequently, whether managed by the military or by a business, existing military relocation solutions tend to suffer from a biased focus based on underlying motives, rather than consistently prioritizing the needs of the relocating service member. Hence, despite all the efforts and incentives, known solutions tend to be biased, and efficiency and effectiveness become slaves to procedure and profitability, while many of the long felt needs remain largely unresolved.

Accordingly, a serious need remains for efficient, simple, and effective relocation systems and methods that ensure provision of objective relocation assistance, especially at the gaining end of a military relocation. Many other problems, deficiencies, disadvantages, obstacles, unmet needs, and challenges of the prior art will be evident to those of skill in the art, particularly to those military personnel who have had to repeatedly endure the hardships of relocation.

### OBJECTIVES

Some of the more basic objectives of most permutations of the present inventions are to improve over the prior art and to enable help for military service members as they and/or their families transition into new communities and duty assignments. In the process, variations of the present inventions aim to elevate an appreciation of military personnel, to recognize the challenges that they face in a relocation and, based on such recognition, to provide a better needs-based approach to overcoming those challenges. A secondary objective of several variations of the present inventions is to provide a comprehensive, professional relocation system and method for military service members and their families, particularly a system and method that ensure objective, multi-industry and/or multi-faceted help on the receiving end of a military relocation. A related objective of variations of the present inventions is to facilitate the provision of the best and/or most helpful services for military personnel and their families over the course of a move, while conveying a continuous message of respect and appreciation for the tremendous levels of sacrifice they provide for their fellow countrymen.

Along with the above objectives, variations of the present inventions are also directed to facilitate access between relocating military personnel and the most ideal offering of both government-funded and private-sector services that they will likely need in the process of relocating, while continually and systematically subordinating the needs of the service providers to those of the military personnel and/or their families.

Objectives of some variations of the present inventions also include overcoming the various kinds of limitations, obstacles and challenges of the prior art in ways that help optimize efficiency and effectiveness. Related objectives include affordably addressing the needs without charging significant additional fees or expenses to the military personnel or the military itself, while also providing a reproducible system that can be readily commercialized, easily implemented, easily structured, and easily used in each instance. Many other objectives will be evident either to military personnel and/or to those of skill in the pertinent arts.

### SUMMARY OF THE INVENTION

While it would be an incredible dream for a single solution to address all the referenced objectives, at least one of those objectives is preferably met, in whole or in part, by one or more variations of the present invention, according to which a system or method are provided through facility operations that help address multi-industry and/or multi-faceted needs of relocating military service members.

The present inventions provide and/or enable systems and methods to ease the relocation process for military service members and/or their families, preferably by bringing together easy access to all of the gaining end move-in resources that they would typically need into one facility on or near the gaining end station, and preferably also by providing knowledgeable yet objective facility staff to personally assist them with anything and everything they need to get settled in the new community—all preferably at no cost to them.

Some of the systems and methods of the present inventions provide and enable efficient, simple, and effective help for arranging services on the gaining end of a military relocation. Systems and methods according to teachings of various aspects of the inventions are preferably adapted to provide objective relocation assistance at the gaining end of a military relocation and to help objectively arrange services from community-based service providers. Alternative embodiments make similar provisions both at the sending end and the gaining end of a military relocation.

Many if not most embodiments of the present inventions are centered on an enabling facility that is adapted based on a department store model where clients are assisted by objective specialists and are able to access a variety of relocation services on the spot. More particularly, when used, preferred aspects of the present inventions remove and ease the burdens from military personnel relocating to a new community by providing a single, convenient facility where and through which they can obtain most of the gaining end services and products needed to relocate, including not only services and products arranged and/or funded directly through military programs, but also services and products available directly from or through community-based service providers. The systems and methods of the current inventions have not been used in the prior art, and they help resolve previously long-felt needs by providing for less stressful, more efficient, and less costly military personnel relocations.

Relocation facilities that are designed in line with teachings of the present inventions are preferably divided into separate areas where clients can meet or confer with various relocation specialists and/or community-based relocation service providers. For example, although some areas in some embodiments may be equipped to be versatile enough for serving multiple alternative functions, some areas are preferably set aside for clients to meet with objective real estate specialists and/or agents, while other areas are equipped for multi-media exchanges with service provider representatives (such as for insurance, banking, investments, and retirement services), while still other areas are equipped for either face-to-face or remote conference with other service providers (such as for appliance and furniture rental, auto purchase services, title services, community information services, home security services, and utility providers (including cable, phone, mobile phone, and internet services.)

For military service members going through a relocation, many systems and methods embodying the present inventions help alleviate the stress of going all over town, standing in long lines, and wasting time and money trying to get a full spectrum of community-based services arranged in a new community. As a result, many embodiments of the present inventions help transform the complex, emotional and lengthy process of relocation into a simple, comforting and, most importantly, human process for the relocating families that are served—all preferably at no cost to the relocating personnel.

Aspects of the present inventions are expected to be generally defined in appended claims, as they may be added, supplemented, clarified or amended from time to time. However, those of skill in the art will recognize many other aspects and variations of the inventions from the foregoing descriptions and from the following descriptions of preferred embodiments, especially when considered in light of the prior art. It must be understood that many other aspects of the inventions and many other alternatives, variations, substitutions and modifications will also fall within the scope of the inventions, both those inventions that are now claimed and those inventions that are described but not yet claimed.

### BRIEF DESCRIPTION OF THE DRAWINGS

A better understanding of the present inventions and some of the corresponding embodiments may be had by reference to the drawing figures wherein:

FIG. 1 is a conceptual perspective view of a preferred facility 100 designed, operated and used in accord with many of the teachings of the present invention.

FIG. 1A is an enlarged, detail view of FIG. 1, with focus on facility 100 and with doors 105 and 106 being shown in transparent lines.

FIG. 2 is a more-detailed conceptual perspective view of an individual conference space within a preferred embodiment of a facility 100 as conceptually illustrated in FIG. 1.

FIG. 3 is a floor plan view of the interior of a preferred embodiment of an enabling facility 100 of the type conceptually illustrated in FIG. 1.

FIG. 4 is a flow chart of certain aspects of a preferred method of the present invention.

### DESCRIPTION OF PREFERRED EMBODIMENTS

The various preferred and alternative embodiments described further below typically involve a physical facility 100 together with managed operations that provide and enable systems and methods according to teachings of the present inventions.

From an overview perspective, we first give some general information and then describe various general concepts in terms focused on advantages provided to users by reference to preferred embodiments. That initial descriptive section is followed by a further description of more general aspects and general features offered, with some particular reference to certain embodiments. A third section of these descriptions then highlights more detailed descriptions of various particular aspects of an exemplary facility 100 and related operations that embody and enable many aspects of the inventions. A fourth section will then describe aspects of related business methods and exemplary personnel relocation processes enabled by various embodiments of the present invention.

Even though the descriptions are subdivided into various sections, it should be understood that each section can be illuminated by other sections of the description. Many aspects of the methods and processes of the illustrated embodiments (and of the various permutations of the inventions), for instance, are described in detail and from different perspectives in each of the sections of these descriptions. Likewise, the physical structure of variations of facility 100, and the corresponding advantages and features, are also described in almost every section of these descriptions.

The reader should recognize that reference to advantages, features, functions or other characteristics of particular aspects may in fact also apply or apply more appropriately to other aspects of the referenced embodiments, as will be evident to those of skill in the art. From a convenience perspective, for instance, characteristics are often described with reference to “facility 100”, even though the characteristic may actually be more applicable (or also applicable) to preferred operations of facility 100 or to preferred operations of data processing systems 192 that are associated with facility 100, or even to the preferred actions of personnel who are associated with such preferred operations. The opposite may likewise be applicable, such as when characteristics are described with reference to one particular aspect even though such description would be understood by those of skill in the art to also apply (or apply more appropriately) to the overall system of preferred embodiments, or even to completely different aspects of preferred embodiments.

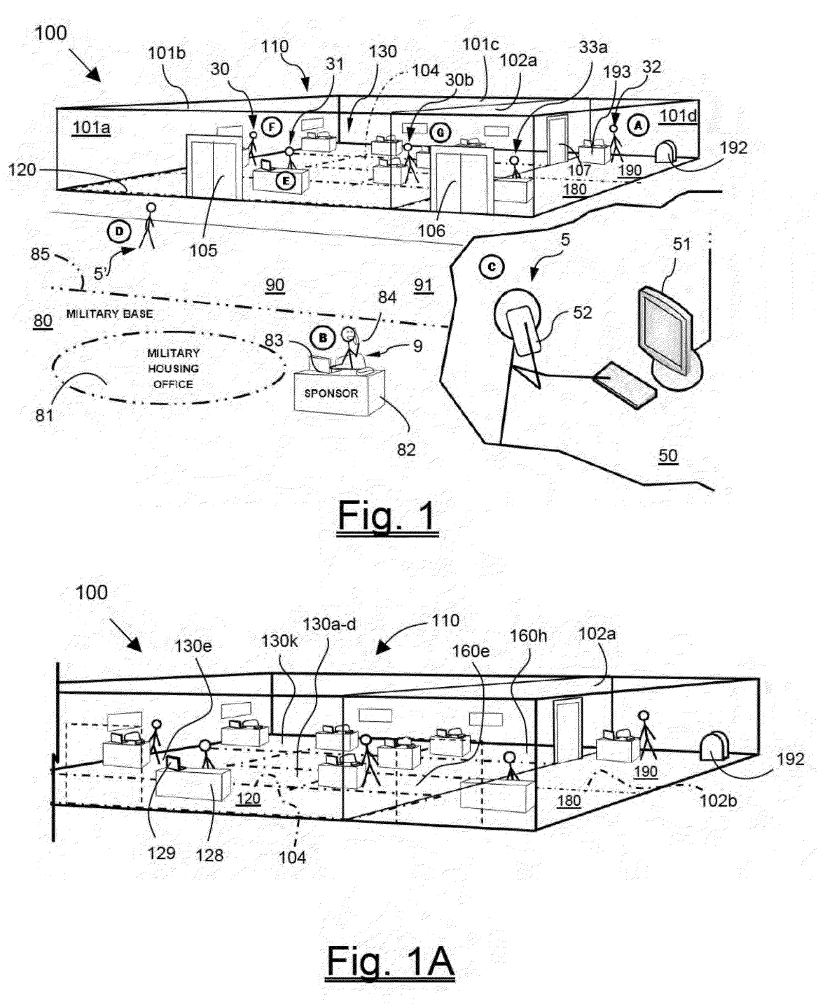

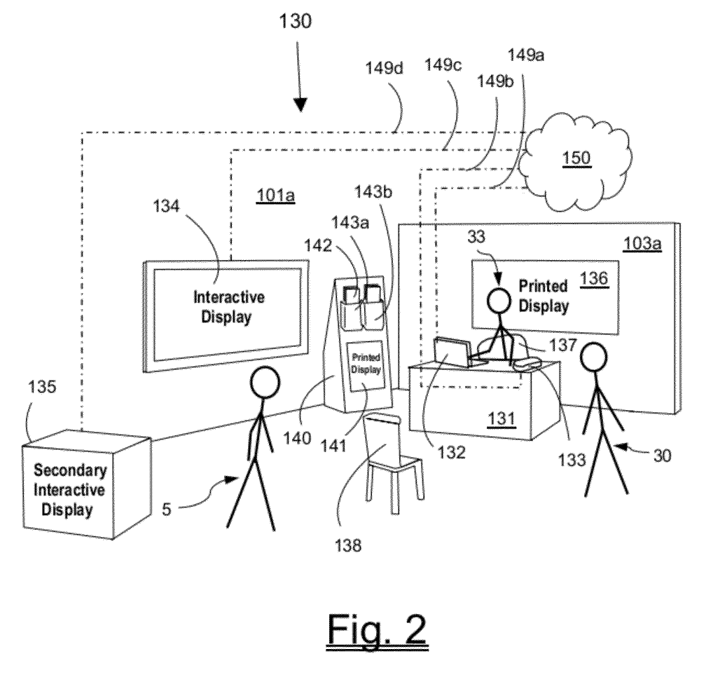

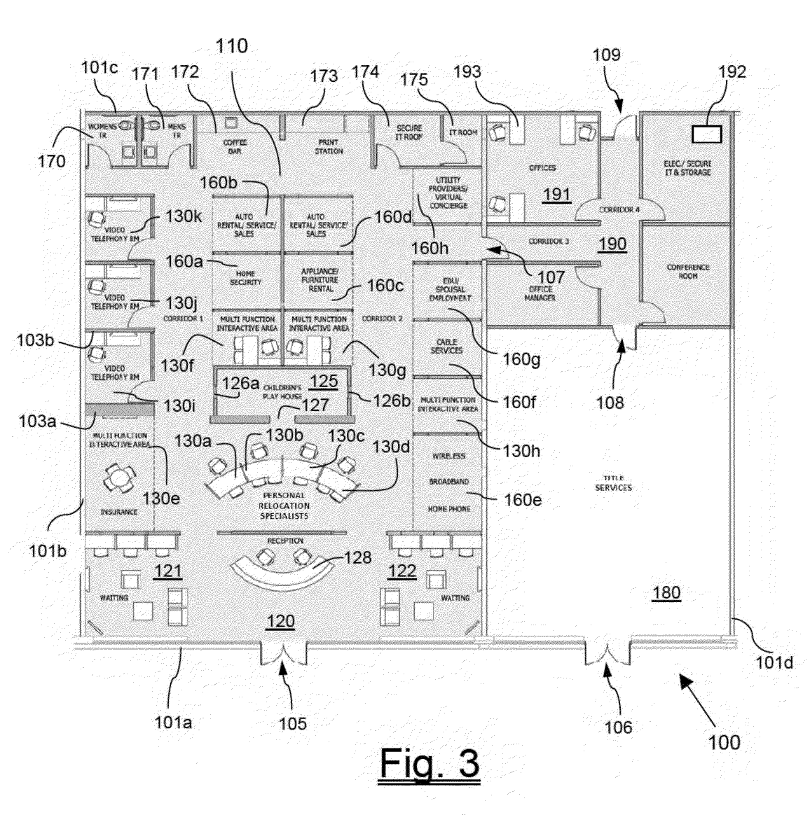

It may also be helpful to point out that, while some aspects of the preferred embodiments involve a computerized data management system 192 (illustrated as a non-descript object in the management offices 190 of FIGS. 1, 1A and 3), the particular location and other routine details about those elements are not expected to be critical to the inventions. Perhaps because such details are not expected to be critical, such data management elements are referenced loosely with varying labels ranging from “computer database” to “server” to “data processing system” to just “system,” or the like, according to whatever particular aspect of a data management system seems most relevant in the context of the various portions of these descriptions, while the same reference number “192” and non-descript object is referenced throughout. As should be understood by those of skill in the art, all such references generally refer to a computerized data storage, processing and management system that may reside on any number of actual or virtual computer servers and/or data storage and data processing devices that are networked through a data network such as network 150 (referenced as a non-descript cloud in FIG. 2). Likewise, it should be recognized that such data management elements 192 are programmed with software to enable the functions as described. While alternative embodiments may also involve remote processers, “the cloud,” laptops, wireless connections, etc., it should be understood that location or other details are not likely to be central to the inventions unless, the course of prosecuting or upholding validity of the corresponding patent claims requires as much.

Alternative preferred embodiments are occasionally described or illustrated in paragraphs, sentences or drawings that are clearly differentiated from those for other preferred embodiments, but this is often not the case. Instead, most alternative preferred embodiments are described in the context of a sentence or group of sentences merely by reference to one or more alternatives for an individual component or step. Parentheses are used occasionally to make reference to such alternatives in the same sentence as a more primary embodiment, in hopes of minimizing distraction for readers attempting to understand both the primary embodiment as well as noted alternatives. The reader should understand that, whenever alternative components, steps or the like are referenced in this latter manner (or in any manner), each such alternative component, step or the like may be used in virtually any combination where the other alternatives are described, illustrated or implied as being used, except perhaps to the extent that one of ordinary skill in the art would clearly recognize that such other combinations would not result in any of the structure, functionality, objects or purposes of the present invention as ultimately claimed. So, even though it may be clear that a particular description refers to a specific alternative embodiment, it should be understood that the same description also illuminates an understanding of numerous alternatives, albeit indirectly.

To enable a reading that more easily applies despite such implied alternatives, parts of one embodiment are sometimes referenced using reference numbers that are comparable to comparable parts in other embodiments. The FIG. 1 conceptual embodiment, for instance, has many similarities with the more particular embodiment illustrated in FIG. 3, such that various parts in both have the same exact reference numbers, even though there are also a few noticeable differences.

Comparable parts of the illustrated embodiments are also occasionally referenced with the same Arabic reference number when discussed at a more generic level, although added alphanumeric digits may be added at the more specific level to differentiate one of the comparable parts from others in the same generic category. Conference areas 130a-130k and 160a-160h of FIG. 3, for instance, are referenced as conference area 130 when discussed at a more generic level in FIG. 2.

### Some Advantages of the Embodiments

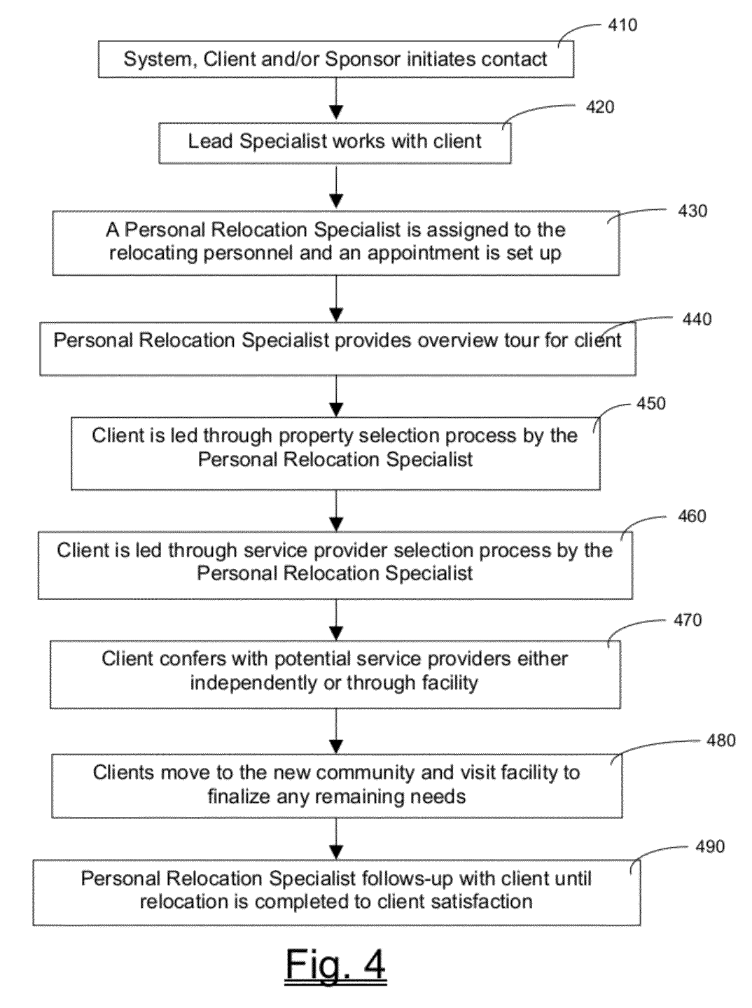

Many of the advantages of the disclosed systems and methods described herein center on the convenience, efficiency and effectiveness provided by an enabling physical facility 100 such as those described with reference to FIGS. 1-3. Such advantages are also enhanced through managed operation of such a facility 100 in line with procedural teachings of the preferred embodiments, as described throughout all portions of these descriptions, with select aspects of such procedural teachings being depicted in part in FIG. 4.

In addition to various objectives referenced in the foregoing Background and Summary descriptions, an objective of the structure and operation of facility 100 and the related data management systems 192 is to provide a facility where a relocating military service member 5 can have easy access to a comprehensive collection of gaining-end, relocation-related services, preferably at or through a single location, preferably under a single roof—a one-stop, full-spectrum “relocation center” 100.

For vocabulary, any reference to a “military service member” or the like should be understood as referring to a military service member and/or his or her authorized representative (which may be a family member, to the extent that such family member is an authorized representative of the service member). Although “military service member” and “client” are sometimes used interchangeably, the “client” and “clients” designations are intended to encompass not only the military service member (and his or her authorized representative) but also all members of that military service member's family.

To be optimal for its military context, the enabling facility 100 is conveniently located within a “military community”—a term that will be used here to refer to the combination of a military base 80 and all surrounding and/or neighboring communities 90 (whereas the more simple term “community” will generally be used to refer to communities that are generally NOT within the military base 80). Accordingly, descriptive reference to locating facility 100 within the military community should be understood to mean locating facility 100 either within a military base 80, or within a short transportation distance to such a military base 80. Such a short transportation distance is preferably less than five miles driving distance from the base 80, either from a gate of the base or from a perimeter 85 of the base 80, and more preferred embodiments shorten such distance to no more than one mile or two miles.

The comprehensive collection of services accessible through a facility 100 embodiment preferably includes private-sector and/or community-based services that are likely to be essential for relocating military personnel and their families (“primary services”) in their destination military community 90. Other preferred embodiments also offer access to DoD-operated and/or DoD-funded services together with the primary services. Access to services that are often helpful but are less than likely to be essential (“secondary services”) are also preferably provided through the same relocation center 100, although such secondary services are less critical. The result provides a comprehensive and professional relocation service for military members and their families as they transition into a new home, community 90, and duty assignment associated with base 80.

Further advantages are available through embodiments that provide a convenient way for a military family to secure all needed living arrangements upon arriving at a new receiving station 80 near a new civilian community 90. The comprehensive collection of services for such embodiments is made available in part through an objective relocation specialist 30 while also being provided in part through a cadre of multi-industry representatives 33 who are accessible at or through the relocation center 100. Such multi-industry representatives 33 preferably include captive yet independent service provider representatives 33 (who are not always personally present at facility 100) as well as unbiased military relocation specialists 30 (who are preferably always personally present at facility 100). Such captive yet independent representatives 33 are engaged, trained and compensated directly by the independent service providers (both governmental and community-based providers in some preferred embodiments), while the unbiased specialists 30 are preferably not employed or otherwise engaged by any of the independent service providers. By “independent”, it should be understood that representatives 33 are employed by enterprises that are not the same as (and, preferably, are not commonly owned with) the enterprise of management 32. By making the mixed cadre and full-spectrum of multi-industry services accessible at the same relocation center 100, preferred embodiments of the present inventions overcome many of the problems and limitations of the prior art. Preferred embodiments of some of the present inventions also systematically simplify many of the steps required of military personnel during a relocation, while making it comparatively easy for each type of service provider to meet the relocation-related needs. This provides the clients the opportunity to secure most all services they need from or through industry and unbiased sources.

Another advantageous aspect of certain preferred embodiments is the delivery of a department store model approach to meet military relocation needs, enabling relocating military personnel 5 access to services in part by creating an efficient platform for regional and national companies to cater to clients' needs. Through one location, an easy to use website, and a simplified enrollment form, preferred embodiments reduce waste and frustration, and help relocating military personnel overcome the needless inconveniences of settling into a new community.

Preferred embodiments are not exclusively dedicated to particular service providers, but instead use an inclusive platform that is open to all qualified service providers. One or more alternative embodiments, however, facilitate service availability through incorporation of agreements with carefully-selected national providers that are thought to provide the best service to the relocating personnel and their families.

### Select General Features of Illustrated Embodiments

The described embodiments feature a menu of multi-industry, community-based, and multi-faceted services for helping relocating personnel 5 and their families that tend to be needed on the gaining end of a military relocation. Such services (for reference, “gaining end services”) are multi-industry in that they include services from three or more industries. Such services and their providers are “community-based” in that they include services and service providers, respectively, that are provided in the community 90 (in contrast to services provided exclusively on the base 80) and by providers with offices located in the community 90 (rather than exclusively on the base 80). A non-exclusive list of such three or more industries and the different types of services provided through preferred embodiments includes (without limitation): realty industries; mortgage and financing industries; utility industries; data communication industries such as for TV, phone and internet; furniture purchase and rental industries; title, escrow, and closing services; education industries; banking and insurance; home security industries; automotive industries; community information services; voter registrations and change of address services.

The services that are accessible through facility 100 are preferably multi-faceted in that they include multiple (i.e., competing) providers of services from one or more of the multiple industries represented. For instance, the menu of services in some embodiments includes both national and local providers for at least in-house apartment locating, real estate and title services, utility hookups and deposit waiver assistance, banking, insurance, mortgage, investments, home security services, broadband and wireless internet, television, furniture rentals and sales, and automobile dealers. Preferred embodiments provide access to all of these services and more, all under one roof. By deriving revenue through licensing and marketing agreements with the providers of gaining end services, embodiments provide these services at no cost to the military member 5 or the Department of Defense (“DoD”).

By incorporating the department store model characteristics of the embodiment, facility 100 helps alleviate the stress of having the military service member going all over community 90, getting lost, standing in long lines, and wasting time and money trying to get setup in a new home. As a result, embodiments of the present inventions help transform the complex, emotional and lengthy process of relocation into a simple, comforting and, most importantly, human process for the relocating families that are served—all at no cost to the relocating personnel.

Somewhat analogous to a department store approach, embodiments of the present inventions involve making the multi-industry relocation service providers available through a common physical facility 100, where a cadre of several of the more critical gaining end relocation services is available through a number of vendors. Although preferred embodiments preferably provide open access to all service providers based in community 90 for multiple industries, greater access can be provided in some embodiments to service providers that consistently provide better overall service to military personnel and their families, as chosen by system management 32 through a competitive process. Despite the different sources for the various services, embodiments offer each of such core relocation services under a single roof, in some ways analogous to a focused department store, to serve the needs of the personnel moving to a new location.

Another feature of preferred embodiments is the ability to provide relocating personnel with a personal relocation specialist 30 who assists them before, during and after the move. Preferred embodiments ideally help with things like finding a place to live, assisting with deposit waivers, turning on utilities, selecting cable/phone/Internet packages, obtaining car and home insurance, and providing information about local schools, health care providers and other things a family needs to begin living in a new community. By staffing such specialists on a salaried basis, without compensation directly from any of the gaining end service providers, the objectivity of such specialists is ensured.

For a military service member, and any members of his or her family, (for our purposes, “client(s)”), use of preferred embodiments will generally commence with (or following) the issuance of military orders directing the military service member to relocate from a first military station (the “station of origin”) to a different military station (the “receiving station”). Such orders (for reference, “military relocation orders”) may be in any form. For a broader understanding of preferred and alternative embodiments, general reference to “military relocation orders” (occasionally shortened to “orders”) should be understood to include (without limitation): Permanent Change of Station (“PCS”) orders, Temporary Change of Station (“TCS”) orders, Temporary Duty (“TDY”) orders, as well as any other military orders that are commonly associated with the course of advancing a military relocation, such as TLE, TLA, TQSA, FTA, or DLA orders, and any other known form of military orders relating to military personnel relocation. Although a client can commence use of the embodiments prior to actual issuance of military relocation orders, the process generally begins with the issuance or anticipated issuance of military relocation orders.

### Particular Description of Exemplary Facilities and Related Operations

Reference is made to FIGS. 1-4, which provide illustrations of an exemplary facility 100 and related operations that combine to provide preferred systems and methods according to the teachings of various aspects of the present inventions.

The location of facility 100 relative to a military base 80 and a neighboring community 90 provides an advantageous aspect of preferred embodiments. While aspects of some of the invention variations provide that an operating facility be located on or near a military base, preferably within five miles driving distance of a gate to the military base, facility 100 is illustrated as being situated across street 92 from military base 80. This location positions the facility 100 in the neighboring community 90—i.e., a civilian community adjacent to military base 80—and within less than a mile of the perimeter of base 80. The close proximity to base 80 allows easy access to service members who are visiting or are stationed on base 80. The location of facility 100 in community 90 also provides the advantage of convenient access to service providers that are based in community 90, as well as to the properties and other features of community 90.

Other alternative embodiments position all or part of the operation of facility 100 within the geographical perimeter of base 80, preferably in or within two or three city blocks of a Military Housing Office 81 that serves service members stationed with operations on the base 80. While the location on or near base 80 enhances several advantages offered by facility 100, other facets of its operation preferably provide convenient and efficient use even before the military service member approaches facility 100.

With reference to FIG. 1, facility 100 and related operations are adapted to allow a military service member client 5 initial interaction and registration with facility 100 either in person or from a remote location 50. Most preferably, although not with early embodiments, a client's first interaction with the operation of facility 100 (step 410 in FIG. 4) is automatically prompted by a computerized prompting system in direct response to the actual or anticipated issuance of one or more types of military relocation orders directing client 5 to relocate to a station associated with military base 80. Instead of such an automated prompting, other currently preferred embodiments rely instead largely on the involvement of a military sponsor 9, who is stationed at a location 82 on the gaining end of a military relocation and is assigned by the associated military operations to assist the client 5 during an ordered relocation. While the sponsor 9 may be assigned to client 5 before the first relocation order is actually issued, by regularly working with known sponsors 9 as soon as they are known, the operation of facility 100 is better able to register and serve client 5 before the corresponding military relocation orders are finalized. Management of facility 100 does not offer any financial incentive to sponsors 9. However, because the operation of facility 100 has a high likelihood of increasing the sponsors' success for a particular client 5, sponsor 9 is inherently incented to refer client 5 to facility 100 during the early stages of preparing for a relocation, either shortly after or even before military relocation orders have been issued for the client 5. Through dissemination of marketing information to known military sponsors 9, management 32 of facility 100 encourages such sponsors 9 to cause client 5 to make initial contact with facility 100.

Due to the convenient location of facility 100 on or near base 80, initial contact step 410 and registration (or enrollment) in the system of facility 100 can take place in person by the client 5 whenever the client might be on-site at base 80 or in the neighboring community 90. Only to differentiate from the depiction of client 5 at the remote location 50, client 5 is numbered in FIG. 1 as client 5′ in the location where walking across street 91 into facility 100, but it should be understood that client 5 and client 5′ are otherwise the same. With such “in person” (or “walk-in”) contacts and registrations, client 5 travels to facility 100 with or without advance notice and walks in the front door 105 of facility 100, where client 5 is then attended to first by a lead specialist 31. The lead specialists 31 on staff at facility 100 serve as a receptionist in the principal reception area 120 for facility 100. Such lead specialists are trained on the offerings provided through facility 100 and are responsible to welcome clients and prospective clients and to begin the process of understanding the likely needs of prospective clients. With “in-person” cases, lead specialist 31 uses a data terminal 29 located at the reception desk 28 of the reception area 120 (or another convenient terminal such as the other terminals in facility 100) in order to process an enrollment/registration for client 5 while client 5 waits in waiting areas 121 or 122.

Alternatively, while facility 100 in presently preferred embodiments is located on or near the base 80 that is on the gaining end of a military relocation, a client's initial interaction step 410 with facility 100 is usually initiated by client 5 from a remote location 50. Such an initial “remote-in” initial contact is more typical than a walk-in initial contact. Common remote locations 50 will be the prospective client's home or office at his or her station of origin, on the sending end of a military relocation, which may even be an overseas remote location. With alternative embodiments where a facility like facility 100 is located near such station of origin, that station of origin facility will commonly serve as the remote location 50 depicted in FIG. 1. With remote-in initial contacts 410, client 5 makes such initial contact through the internet, via e-mail, or by phone from remote location 50, either via a remote user data terminal 51 or via a phone connection (or the equivalent) 52.

The second step 420 (shown in the flow chart of FIG. 4) in the preferred process involves a lead specialist 31 working with the client, particularly when the typical initial contact step 410 is made from the remote location 50 via remote terminal 51 or phone 52. In cases where a live lead specialist 31 is not available at the moment of contact 410, a computerized data management system 192 creates an initial contact message, which is assigned to a lead specialist 31. When initial contact 410 is made during normal business hours, the assigned lead specialist 31 preferably then returns the initial contact message within ten minutes of receiving the same. When initial contact 410 is made during non-working hours, the assigned lead specialist 31 preferably then returns the initial contact message within the first hour of the next morning on which facility 100 is open for business. As soon as the direct connection with client 5 is made by a lead specialist 31 (i.e., either because the specialist is immediately available or returned the initial contact according to the timing discussed above), then specialist 31 has two basic task objectives.

A lead specialist's two basic task objectives for an initial contact are: (i) identify sufficient personal identification information to register and particularly identify client 5 in the system database 192, and (ii) assess some level of the likely scope of services needed for the client 5 (such as whether the client appears to be either a home purchasing or a home renting client). Based on that basic information, assuming as much can be identified and the client 5 is registered properly, the lead specialist 31 then refers the client 5 to a personal relocation specialist 30 staffed by facility management 32. To ensure that a lead specialist 31 is available for both walk-in and remote-in contacts, facility 100 preferably is staffed with two or more lead specialists 31, at least during peak working hours. Lead specialists 31 are preferably part-time employees of the business that provides management of facility 100, and they are preferably compensated on a salaried and/or hourly-pay basis. Successful performance for lead specialists 31 is preferably determined in large part based on subjective assessment of management 32 but is also based in part on their success in following-up with initial contacts within the timing expectations of the system, and also based in part on the number or percentage of assigned initial contacts that they are able to convert into registration/enrollment in data management system 192.

Assuming an initial contact from a prospective client results in registration/enrollment of that client 5 in the data management system 192 of facility 100, a personal relocation specialist 30 is assigned for the client 5. The system 192 also prompts specialists 30, 31 to schedule a follow-up appointment (either by phone or in person) between the client 5 and the assigned relocation specialist 30. Preferably, facility 100 has multiple personal relocation specialists 30 available during all working hours, and four to seven personal relocation specialists 30 are available at facility 100 during peak working hours and special enrollment events. Preferably, each personal relocation specialist 30 is a relative expert on the unique aspects of the neighborhoods and schools on the military base 80 and in the community(ies) 90 adjacent to military base 80.

Each personal relocation specialist 30 is also knowledgeable about the corresponding services that are available in the various communities 90 adjacent to and/or surrounding military base 80. The relocation specialists 30 are trained to ensure that every element of the clients' relocation is addressed successfully. They personally serve each client 5 that enters the relocation center 100 and guide them through the related processes and introduce them to service providers 33 while advising them on the magnitude of the corresponding needs. These individuals 30 search all of the local service offerings to help specifically tailor options for the wishes of the clients 5 and the solutions that best meet their needs. Unlike Internet offerings where much is left to chance, the personal relocation specialists 30 are trained to get to know the clients and objectively assess all of their relocation needs in order to help them settle into their new military community 90.

The client 5 registers and sets up appointments either in person or by phone or e-mail, or through a website that is designed to interface with the data management system 192 associated with facility 100 and its operations. As of the filing date of this patent application, one preferred embodiment of such a website is publicly available on the Internet at the url address of www.housing1source.com (for reference, the “H1S Website”), the entire contents of which are incorporated here by this reference. When registered in the data management system 192, clients 5 are then assigned a personal relocation specialist 30 who assists them with the relocation process. The personal relocation specialist 30 manages the clients' needs from the first appointment to after the day they finally settle into their new home or apartment. Although service provider representatives 33 may not be personally present in the facility 100 at all times, the facility 100 is staffed during all working hours by relocation specialists 30. Conference areas 30a-30p (numbered in FIG. 3 and illustrated generically in FIG. 2) also include communication equipment such as a telephone 133 and a data terminal 132 adapted for easy internet access to the websites for clients to communicate with representatives 33 of the various corresponding gaining end service providers. Several (if not all, in alternative embodiments) of the conference areas 30a-30p (numbered in FIG. 3 and illustrated generically in FIG. 2) also include printed materials 142, graphic and/or print displays 136, 141, and/or multi-media interfaces 134, 135, all for learning more about available options and services and the corresponding service providers. Irrespective of whether independent representatives 33 are present on site at facility 100, each client's main contact is their assigned personal relocation specialist 30.

The enrollment/registration process for facility 100 preferably prompts client 5 for (and preferably obtains) client's informed consent for facility 100 to receive subsequent automatic updates on any military relocation orders for client 5 from the corresponding military databases. With embodiments that obtain as much, the computerized data management system 192 of facility 100 then preferably uses updates and new notices about a client's military relocation orders to confirm the available options and programs for a particular client 5. Such updates and notices are also used by the computerized data management system 192 of facility 100 to adjust timelines and help drive completion of target completion steps for the corresponding client 5.

To facilitate tracking and prompting of progress for each client 5, database server 192 is adapted with a CRM data management system and supporting software (for reference, the “CRM-DMS”). Once a client 5 is registered in the computerized database 192 for facility 100, the CRM-DMS prompts the assigned personal relocation specialist 30 to continue relocation progress for client 5 until the corresponding relocation file is closed. Preferably, once the planned date for relocation is identified in the record for a particular client 5, the CRM-DMS helps make sure that reminder prompts are generated at set time periods before the target relocation date. For instance, through e-mail (or other alternative automated messaging arrangement) some preferred embodiments automatically remind both the client 5 and their assigned sponsor 9, as well as the facility 100 relocation specialist 30 who is assigned to help client 5 in the process of the move. Alternatively, in embodiments that are slightly more geared for personal interaction, the CRM system of facility 100 notifies the assigned relocation specialist 30 instead of or, alternatively, up to a day before, notifying the sponsor 9 and client 5, in order to allow the relocation specialist 30 the opportunity to personally contact both the sponsor 9 and client 5 in order to maximize the personal aspect of help provided by specialists 30.

As will be appreciated, the layout of facility 100 enables various aspects of many of the invention variations, as does the way facility 100 is operated. FIGS. 1 and 1A show conceptual perspective views of facility 100; whereas FIG. 3 shows a more detailed and more particular floor plan for a preferred form of facility 100. The limits of the interior space of preferred facility 100 are defined by outer walls 101a-101d. Floor-to-ceiling interior walls 102a and 102b then preferably divide the entire interior space into three separately enclosed spaces 110, 180, 190. The latter two separately enclosed spaces are a special class provider space 180 and administrative offices 190, both of which will be discussed elsewhere herein.

The most important of the three separately enclosed spaces is a main interior space 110 that is primarily dedicated to client interaction. For basic functionality, main interior space 110 is subdivided into a plurality of client conference spaces 120, 130a-k, 160a-h (many of which are not shown in FIGS. 1-1A but are shown and numbered in FIG. 3). Such client conference spaces are provided to allow a military service member 5 or his or her representative to meet or otherwise confer with specialists 30, 31, 33 who are knowledgeable about how to help newcomer military personnel arrange for services in the community 90 around a military base 80. The general layout of main interior space 110 allows clients 5 to (a) learn about the community 90 and the properties and services available in that community, and to (b) meet and/or confer with the various specialists 30, 31, 33 that are made available to clients 5 by and through facility 100.

Space 110 is preferably the largest of the three separately enclosed spaces 110, 180, 190, while it is further subdivided by partition walls 103 generally along the dividing lines 104 shown conceptually in FIGS. 1-1A. Partition walls 103 subdivide space 110 into a number of smaller spaces 120, 130a-k, 160a-h, 170-175 (many of which are shown and numbered in FIG. 3). Space 120 serves as a reception area; spaces 130a-130k, 160a-160h serve as conference spaces for reviewing information and/or conferring directly or indirectly with service provider representatives 33; and spaces 170-175 serve support functions as will be described further herein. The particulars of spaces 130a-130k, 160a-160h vary from simple cubicles to multimedia showrooms.

The orientation of facility 100 preferably situates the front of facility 100 in an orientation that generally faces toward military base 80. The front wall 101a of facility 100 has a primary exterior entrance 105 that allows clients 5′ to freely walk into the primary client space 110 of facility 100. (As will be discussed elsewhere, the front wall 101a preferably also has an independent entrance 106 for title services space 180.) The first/front portion of client space 110 is a reception area 120, with a reception desk 128 and seating accommodations. Lead specialists 31 (or alternative objective staff 30, 32) are stationed to serve as a receptionist at the reception desk 128, to greet and serve walk-in clients 5′ upon entry into facility 100 (one aspect of step 420 in FIG. 4). To facilitate step 420, the reception desk 128 has a user terminal 129 for lead specialist/receptionist 31 to access the data processing server 192. Using terminal 129, lead specialist/receptionist 31 is able to register/enroll walk-in clients 5′ in the system 192 and to otherwise make sure that an appropriate personal relocation specialist 30 is assigned to the client 5 and that an appointment is set up for client 5 to meet with that specialist 30. Further, if a previously-assigned personal relocation specialist 30 is not available when a client 5 happens to be on-site at facility 100, the lead specialist 31 can make record adjustments so that another relocation specialist 30 can help client 5 either permanently or temporarily. Once registration is completed and/or confirmed by the lead specialist/receptionist 31 in step 420, and once the identity of the appropriate relocation specialist 30 and an appointment time is assigned and/or confirmed (step 430 in FIG. 4), the client 5 is then allowed to preview informational materials about available services while waiting in waiting areas 121, 122 until their appointment time and/or until their relocation specialist 30 is otherwise available.

Once the assigned relocation specialist 30 is available, the lead specialist 31 makes sure that client 5 and specialist 30 are introduced to each other. The personal relocation specialist 30 then introduces client 5 to the services available through facility 100 by providing an overview tour of the primary space 110 and each of its individual conference areas 130a-k, 160a-h. During that initial overview tour (step 440 in FIG. 4), the personal relocation specialist 30 guides client 5 past each of the individual conference areas 130a-k, 160a-h with brief reference to the various offerings available in each such space.

Later, after the property selection process (step 450) is complete, relocation specialist then leads the client 5 through a service provider selection process (step 460). Each space 130a-k, 160a-h is preferably provided with a desk 131 and seating furniture 137-138 to make the process more comfortable and efficient. Desk 131 is also provided with a data processing terminal 132 and telephone communication equipment 133. As will be evident, each of the communication devices 131-132, 134-135 are connected to the data management system 192 through network 150. While such connections may be hardwired or wireless in alternative embodiments, they are depicted as hardwired in hardwire connections 149a-149d, respectively, in the illustration of FIG. 2.

With reference to FIG. 3, for instance, space 130a has printed displays 136, 141 (numbered by representation in FIG. 2) and printed materials 142 that describe insurance services available for relocating military personnel 5. At least one of the video telephony rooms 130i-130k also has displays and printed information, as well as a video teleconference link to a remote service provider representative 33. At least one video telephony rooms 130i-130k is dedicated to banking service providers operating (including mortgage service providers) in community 90.

In the preferred embodiment of facility 100, while all of the client conference spaces 130a-130k, 160a-160h include seating furniture, desks and telephone and/or data processing terminals for communicating with service provider representatives 33, some of those spaces do not have any interactive displays. Spaces 160a-160h, for instance, do not have such interactive displays in the preferred embodiment. Space 160a is dedicated to home security services available in the community 90. Space 160c is dedicated to appliance/furniture rental services available in community 90. Space 160b and 160d are dedicated to auto rental/service/sales services available in community 90. Preferably as 160b is provided with printed displays 136, 141 and informational materials 142 from one service provider in the community 90; whereas space 160d is provided with such printed displays and information from an independent competing service provider from community 90, where they provider in space 160d competes with the service provider in space 160b in community 90.

Space 160e is dedicated to telecommunications service providers capable of providing home phone service, broadband service, and wireless telecommunications services. Space 160f is dedicated to cable services. Space 160g is dedicated to education services and other career services available in community 90, with particular focus on assistance on the location of career opportunities for family members of client 5. Space 160h is dedicated to utility service providers and virtual concierge. Other spaces 170-175 are support spaces for the entirety of space 110. For instance, spaces 170, 171 are women's and men's restrooms, respectively. Space 172 provides a coffee service and kitchenette with running water, and space 173 provides a print station for printing from system 192. While system 192 is illustrated as being based in offices 190, additional IT rooms 174, 175 are included within space 110, as part of the overall data management system 192.

With reference to FIG. 2, a representative client conference space 130 is shown, which is generically representative of spaces 130a-130k, 160a-160h. Representative space 130 is intended to be representative of aspects of all those client conference spaces, but space 130 most closely corresponds to space 130e of FIGS. 1, 1A and 3. As such, the floor-to-ceiling wall of space 130 have been designated with reference number 101a, and the movable partition wall that helps define space 130 is designated as partition wall 103a (also numbered in FIG. 1). Although aspects of generic space 130 are different within the different types of spaces 130a-130k and 160a-160h, those differences should be evident from other descriptions herein.

With cross reference between FIGS. 2 & 3, each of the spaces 130a-130k is provided with some form of primary interactive display 134, and several are provided with a secondary interactive display 135. The interactive display 134 is in the form of a video teleconference display for each of video telephony rooms 130i-130k. In contrast, interactive display 134 is provided in the form of an interactive touch screen data processing system in one of multi-function interactive areas 130a-130h. As will be evident to those skilled in the art, such interactive touch screens 134 can be adapted for any type of service provider. In the preferred embodiment, however, each of those areas 130a-130h are adaptable for use in the real estate services context as well as other services contexts. In space 130e of the preferred embodiment, a secondary interactive display 135 is also provided. Secondary interactive display 135 may be in any form, but the preferred embodiment utilizes an interactive display that is incorporated into a table top format for displaying a map of available properties in community 90, together with interactive features for zooming in or moving from one location to another on that map. In an alternative embodiment, secondary interactive display 135 may be in the form of a rechargeable handheld unit with GPS locator capabilities. After a client 5 selects one or more properties to consider in community 90, such a handheld unit 135 can be temporarily detached and carried by a client 5 into community 90 for purposes of locating particular properties of interest within that community 90.

As represented generically in FIG. 2 as display stand 140, each of spaces 130a-130k, 160a-160h are also provided with a stand-alone or desktop presentation of information relating to the particular service provider(s) that is being presented in that space 130. From a generic representation standpoint, presentation 140 includes one or more of a printed display 141 and racks 143a-143b for presentation of printed materials 142. The printed materials are in any particular form that may be suitable for providing information about the corresponding service providers and/or services. Each dedicated space is provided with a printed display 136 with basic information about the services and/or service provider for which that space is dedicated. When a representative 33 of a particular independent service provider is available onsite at facility 100, such representative 33 is made available in the corresponding space that is dedicated to presentation of the corresponding services.

With further reference to FIG. 4, personal relocation specialist 30 commences their initial visit with client 5 by conducting an overview tour of the various offerings represented in the main client space 110 of facility 100. Such an overview tour provides a further opportunity for specialist 130 to get to know the particular needs that are likely to be suitable for that particular client 5. During the course of such overview tour (step 440), for instance, banking services are discussed briefly in the context of video telephony spaces 130i-130k, which provides a further opportunity to assess whether client 5 is qualified to purchase a home or is more suitable for considering rental opportunities.

Preferably at commencement (but alternatively upon conclusion) of the overview tour (step 440), if client 5 has young children who need to be watched and/or entertained while the adult reviews offerings of facility 100 in more detail, a Children's Place House Room 125 is provided in the center of the main client space 110. The children's room 125 is provided with child-safe toys for entertaining young children, and specialists 30, 31 are tasked to make sure someone from the staffed positions 30, 31, 32 is watching any children in room 125, for safety's sake. The central location and other features of room 125 help provide an easy arrangement for the adult clients 5 while they are using the various conference spaces 130a-k, 160a-h of facility 100. First, every portion of client space 110 beyond reception area 20 requires escort by a staff person 30, 31, 32, such that adult room 125 is in the escorted portion of space 110. The location in the escorted portion allows adult clients 5 the extra security of knowing that strangers who might be in the waiting area 120 cannot have unescorted access to the room 125 where their kids are playing. Secondly, room 125 has a gated doorway 127 along with large shatterproof side windows 126a-b that allow relatively easy visibility into room 125 from most locations in space 110. The central location also ensures that a parental client 5 can check on their children within no more than a few steps from any of the conference areas 130a-k, 160a-h.

During the course of the overview tour (step 440), each of the service offerings are discussed briefly while the personal relocation specialist walks them past each space and gathers a better understanding of the needs of client 5. For instance, banking services are discussed briefly in the context of video telephony spaces 130i-130k, which provides a further opportunity to assess whether client 5 is qualified to purchase a home or is instead more suitable for considering rental opportunities. As specialist 30 introduces auto provider spaces 160b, 160d, further understanding is gathered as to whether such services would be helpful for the particular client 5. Likewise, as specialist 30 introduces space 160g, specialist 30 is able to gather further information about whether client 5 has family members who need employment services or other educational or career services in community 90.

Preferably, once the overview tour (step 440) is complete, unless more assessment is needed from a banking or mortgage services provider accessible in spaces 130i-k is needed to determine whether client 5 is likely to qualify for buying a home, personal relocation specialist 30 then leads client 5 through a property selection process (step 450). During the property selection process 450, different offerings are made available depending on whether or not client 5 is more suitable for purchase or rental scenarios. For clients that are suitable for purchasing a home, mortgage services and the like are presented, and one of the interactive display areas 130a-130h are used to present MLS offerings (i.e., real estate listings of houses for sale in community 90 through the MLS listing service). If, on the other hand, client 5 is more suited for a rental opportunity, the interactive displays 34, 35 of multi-function interactive areas 130a-130h are adjusted to present informational displays from an apartment and rental home locating service.

While any of multi-function interactive areas 130a-130h may be used for the property selection process 450, some of those spaces are more informal. Namely, spaces 130a-d are adjoining desktop spaces that are each equipped with an interactive touch screen display 134 that is mounted on a swivel platform in a desktop arrangement rather than on a wall 101, 103.

The individual client conference areas 130a-130k, 160a-160h provide spaces where personal relocation specialist 30 can introduce client 5 to the various types of community-based services and service providers that are available on the receiving end of a military relocation. The assortment of community-based services and service providers represented in the various spaces 130a-130k, 160a-160h preferably combine to provide a comprehensive spectrum of the community-based services that are typically useful, if not essential, in the course of relocating to a new community 90.

With reference to FIG. 4, once client 5 has progressed through the property selection process 450, specialist 30 then leads client 5 through a service provider selection process 460. The service provider selection process 460 progresses through a series of service options with specialist 30 escorting client 5 to each of the dedicated spaces within client space 110. In each such space, specialist 30 then presents the offerings that are available in that space 130. When it appears that a particular service is suitable for client 5 and client 5 is ready to make a commitment, specialist 30 then refers client 5 to the independent service provider 33. While representative 33 is represented as a person in FIG. 2 (which is ideal but not always practical), typically such representative 33 is accessible for conference with client 5 through one of the communication devices 132-135. In appropriate cases, specialist 30 will, alternatively, schedule an appointment for client 5 to meet with such representative 33 at the service provider's business location outside the facility 100. Such conference either through communication devices or independently comprise step 470 in FIG. 4.

Once military service member 5 and his or her family moves to the community 90, it is preferred that those clients 5 again visit facility 100 to finalize any remaining needs (step 480). Within system 192, a file for client 5 remains open until such point as specialist 30 designates it as closed. Such closure usually requires specialist 30 to continue with follow-up communications with client 5 until the client 5 is satisfied that all of his or her relocation needs have been fulfilled (step 490 in FIG. 4).

The entire operation of facility 100 is preferably managed by a business enterprise. Separately enclosed interior space 190 is dedicated to serve as administrative offices for management representatives 32. The management offices 190 preferably includes a rear exit door 109 through the back exterior wall 101c so that management representatives can come and go without interrupting interactions with clients 5 in the main space 110 or in the title services space 180. Each of interior walls 102a and 102b includes a lockable door 107 and 108 built therein, to allow preferred embodiments to generally restrict through access into the management office space 190 to employees 30, 31, 32 and/or contract service provider representatives 33 at the facility 100.

In most embodiments that involve use of a computerized system 192, an electronic data file(s) is created to correspond to a particular military service member 5 using the embodiment. The creation of such file(s) is referred to as registering, which is accomplished through a process of registering (or enrolling) the service member 5 on the computerized system 192, together with entry of identifying and descriptive information about the service member 5 and their expected needs. Upon completion of registration, such registration then constitutes a single registration for the entire offering of multi-industry services that are available through facility 100. Such registration may be performed on-site (i.e., at the facility 100) either by facility staff 30, 31 or by the service member 5, or by someone else authorized by the service member to do so. Registration is preferably performed using one of the computer terminals 129 that are available within the physical facility 100. For a presently preferred embodiment, the H1S Website also allows the military service member (or his or her authorized representative) to remotely complete the registration process through a remote user terminal 51 for the same entire offering of multi-industry services.

Once the single registration is complete, the military service member and/or his or her family (collectively, “clients”) 5 can then begin the relocation process before actually relocating to a new military community. More particularly, when a client 5 or their sponsor 9 registers the client, a personal relocation specialist 30 begins guiding them through all the many steps and decisions necessary to get settled in their new military community.

Although alternative embodiments encourage a progression of relocation tasks through document-based checklists, most preferred embodiments do not rely upon a simple checklist. Rather, presently preferred embodiments employ a customer resource management (CRM) program (or other customized software program) to help each assigned personal relocation specialist 30 to advance such a progression for the benefit of each client 5. The customized CRM program is loaded to operate on the data management system 192 for facility 100, which is accessible through both the Internet and the various user terminals in facility 100. In general, although not all tasks are necessarily prompted in a particular order, the specially programmed data management system 192 is programmed to prompt specialist 30 to help and encourage client 5 in completing each of these more general tasks:
1) Confer and preferably meet with a personal relocation specialist 30 to identify and discuss the client's particular relocation needs and preferences.
2) Show around center to identify likely needs;
3) Based on needs and preferences identified above, work with the personal relocation specialist 30 to begin search for real property in either rental or sale category.
4) Refer client 5 to available banking providers to open a new bank/savings account in the community 90 and, particularly if client 5 expects to buy a residential property for the relocation, to preferably obtain an early preapproval for financial needs of the relocation.
5) If buying, refer client 5 to consult with another mortgage company representatives to apply for a mortgage.
6) Refer client 5 to available insurance providers to arrange renters' or homeowners' insurance, as applicable.
7) If client 5 is buying home, help client 5 arrange for title insurance and closing services.
8) Help client 5 sign their residential lease or purchase, making sure it includes a military clause.
9) Re-verify move-in schedule with client 5 (and landlord)
10) Help client 5 connect utilities and (if buying) a security system.
11) Help client 5 select phone, internet and television packages.
12) Refer client 5 to a furniture and appliance rental provider.
13) Refer client 5 to a self-storage unit in the community.
14) Help client 5 complete and send out change of address with United States Post Office.
15) Help client 5 obtain auto insurance and discuss vehicle registration(s) and license(s).

Referring to FIGS. 1, 1A and 3, the reception desk 28 in reception area 120 is manned by one or more of the system level associates 30, 31, 32 serving in the capacity of a receptionist. Preferably, lead specialists 31 serve in the role of receptionist at all times during working hours. It should be understood, though, that personal relocation specialists 30 or management representative 33 can also serve in the role of receptionist 31, particularly when lead specialists 31 are not available or are otherwise occupied in facility 100. Because the receptionist role is typically fulfilled by lead specialists in preferred embodiments, the terms “receptionist” and “lead specialist” are used interchangeably for these descriptions, and the same reference number “31” is used for both.

During a typical visit at facility 100, a client 5 enters the facility 100 through front door 105 and checks-in at reception desk 128. There the client 5 is registered by a lead specialist 31, particularly if he or she has not already registered online. A receptionist 31 then directs the client 5 to one of two waiting areas 121, 122. For at least one embodiment, waiting area 121 is primarily for clients 5 that are thought to have one kind of central need, and waiting area 122 is for clients 5 that are thought to have a different kind of central need. For instance, in one embodiment, clients 5 interested (and presumably approved) to purchase a home in the community 90 will be directed to waiting area 121; whereas those requiring apartment rental or house rental are directed to waiting area 122.

With reference to FIG. 4, once a client 5 is registered at step 410, a lead specialist 31 works with the client 5 at step 420 to begin understanding the likely gaining end needs of the client 5. With basic information gathered by the lead specialist 31, the lead specialist then assigns a personal relocation specialist 30 to work with client 5 and arranges for an appointment for the client 5 to meet their assigned personal relocation specialist 30, whether immediately or at a later time when both are available. The personal relocation specialist 30 will then help the client navigate the department store-like setting of the facility 100 (as depicted in FIGS. 1 and 3), where clients are able to access a variety of services on the spot. The main space 110 of facility 100 is divided into various separate areas 130a-130k, 160a-160h where clients 5 can learn about more particular options and can confer with various service providers 33. In the embodiment variation illustrated in FIG. 3, for example, areas 130a-d are specially-adapted for clients 5 to meet and/or confer more informally with personal relocation specialists 30 who are preferably trained and/or licensed to serve as real estate agents. Training and other hiring measures are also implemented by management 32 to make sure that those personal relocation specialists 30 are knowledgeable about how to review and discuss each of the available community-based service providers that are available through facility 100, while also being knowledgeable about the real estate alternatives in the community 90.

Although individual ones of spaces 130a-130k, 160a-160h are preferably adapted differently, FIG. 2 provides a generic perspective of some of the types of adaptations that are made for such spaces 130a-130k, 160a-160h. Customized variations of those generic elements of FIG. 2 are preferably made for certain types of service providers. Telecommunications service providers in space 160e, for instance, preferably has interactive screens with a large table for displaying more complicated information about the available options. In some embodiments, the informal interactive touch screen stations 130a-d are simplified to just one or two interactive stations. Numerous other areas 160a-160h are adapted for clients 5 to remotely confer and/or meet with service providers of other primary and secondary relocation services without necessarily including interactive displays 134-135.

While some of the service providers occasionally have representatives 33 on-site at facility 100, the one-stop facility 100 also has Video Telephony Rooms 130i-k, which provide video conferencing facilities, so clients can have a face-to-face conference with any service provider representatives that choose to make themselves more available to clients from remote locations. Whether in person or via the media interfaces in the conference spaces, such face-to-face conferences allow a client to discuss more of their gaining end needs even when a corresponding representative is not physically on-site. The facility 100 provides utility hookups, escrow and title services, change of address forms, voter registration, local vehicle registration, and preferably all the information a new family could need or want to connect with their new community 90.

The facility 100 contains a Children's Waiting Room 125 where clients can leave their children to play while they confer with their relocation specialist 30 and/or independent service providers. If the family wants to lease or purchase a house, the facility 100 is staffed with real estate agents who are ready and willing to help them find the perfect home. The providers at each facility 100 will be tailored to the individual markets in which the facility 100 is located.

Once each step in the process is complete, the relocation specialist 30 is once again on hand to help the clients 5 coordinate the next step of the checklist, constantly encouraging progress through steps that can otherwise try the patience of even the most experienced military family.

The embodiments of the process also help spouses and relatives of the service member either find employment and/or find higher education opportunities. By partnering with several state and local agencies, many embodiments provide spouses with information on local job opportunities. In addition, many embodiments work to educate potential employers on the value of hiring military spouses based on demonstrated strong work ethics combined with the fact that they require little or no benefits or medical insurance. Embodiments also work to put the family in touch with all of the available colleges and universities in the area in order for them to take advantage of the military's educational benefits and find the program best suited to their educational needs.

An embodiment may also provide a concierge service that will let the military family know what is happening around town. This comprehensive concierge service keeps clients abreast of all of the activities, points of interest and other details of their new community, including those that offer a military discount. An embodiment may also include a Welcome Home Gift which is a collection of gratuitous products and services from a variety of local businesses. These businesses hope to make the new residents feel welcome with these special discounts and gifts.

Primary personnel operations at the facility 100 are preferably conducted by a for-profit business enterprise (for reference, “management” or “facility management”). Because the drawings illustrate a stick-figure management representative 32, these descriptions will use the same reference number “32” for reference to “management 32.” The reader should understand, however, that management 32 preferably comprises a business enterprise rather than a single individual management representative.

In alternative embodiments, facility management 32 may actually be a combination of businesses and may be either for-profit or not-for-profit, or a combination of for-profit and not-for-profit businesses. Facility management 32 provides the relocation specialist(s) and, preferably, also provides facility support personnel for maintaining and operating the physical facility 100. Reference to “providing” such personnel means that the business makes sure that the corresponding personnel are available on-site during appropriate hours to fulfill their personnel roles and that they are adequately trained, qualified and (if necessary) licensed to perform the job responsibilities of those roles. Although the relocation specialists and facility 100 support personnel are preferably provided as employees of Facility Management 32, they may alternatively be provided as volunteers or as contract workers who are engaged directly by Facility Management 32, or they may also be provided through an independent staffing agency or business that is contracted by Facility Management 32.

Management 32 is generally responsible for operating facility 100 and arranging for its various personnel needs. To review, the operating business enterprise of preferred embodiments generally employs (or otherwise engages) lead specialists 31, relocation specialists 30, and management representatives 32. Management 32 also coordinates and manages relationships with the service providers and their representatives 33 with whom clients 5 are able to contact through facility 100.

In the preferred embodiment, one (or more) service providers—preferably the title services provider—is in a special class and is provided with a more sizable separate space 180 that has separate exterior doors 106 and (preferably) a lockable interior door 108. Given its special class, the relationship with that one (or more) service provider(s) and its representatives 33a in currently preferred embodiments is exceptional when compared with management's relationship with other independent service providers and their representatives such as representative 33b. In preferred embodiments, the separated interior space 180 is preferably dedicated to provision of title insurance services and has its own exterior front door 106.

More particularly, the separate space 180 is preferably managed and rented to an independent title services provider in a more classic landlord-tenant (or tenant-subtenant) relationship with management 32. Despite the more classic landlord-tenant relationship, the relationship is preferably still characterized by special provisions for additional revenue (or credit) payable to management 32 due to identified and/or inherent referrals provided by facility 100 for the benefit of such special class services provider. In some alternative embodiments, the equivalent of such additional revenue from such a special class of service providers is reflected in an elevated rental rate—i.e., a rental rate that is significantly higher than market rates for the location of facility 100 in community 90.

Although less preferred, in some alternative embodiments, the separate space 180 is owned and managed completely independent of management 32. Even further, in some alternative embodiments, there is no business relationship whatsoever between management 32 and the management of separate service provider space 180, except the inherent relationship of being neighboring businesses. Nonetheless, being neighboring businesses enables mutual incidental benefits due to the convenience of operating the other aspects of facility 100 at a location next door to a service provider that is likely to be useful for relocating military personnel.

An important aspect of many variations of the inventions is that measures are taken to ensure that all of the personal relocation specialists 30 (or, in alternative embodiments, some of them), are objective and are unbiased to favor one property or service provider over another. Preferably, although the distinction may seem subtle, such measures also ensure that the personal relocation specialists 30 are not biased to having client 5 acquire any property or service at all unless it is in the client's desire and best interests. Accordingly, the help provided by the personal relocation specialists 30 is relatively objective.

Facility management 32 staffs facility 100 with personal relocation specialists 30 who are trained (and preferably licensed) to provide real estate services (amongst other services) to clients 5. Although not necessarily in every embodiment of every variation of the inventions, the objective character of lead specialists 31 and/or personal relocation specialists 30 (and the help they provide) is preferably achieved in part by facility management 32 providing both lead specialists 31 and personal relocation specialists 30 in a way that ensures such specialists 30, 31 are objective in providing service to clients 5. Such objectivity is ensured, preferably, by providing the specialists 30, 31 for clients 5 without paying the specialists 30, 31 differently if the client 5 chooses one real estate property as opposed to another property. To accomplish as much, the real estate personnel at facility 100 are preferably salaried and paid on a non-commission basis. In the illustrated preferred embodiments, all of the personal relocation specialists 30 (or, in alternative variations, some of those specialists 30) also serve the roles of the real estate personnel, and vice versa. Accordingly, relocation specialists 30 preferably meet most if not all the requirements of licensed real estate agents and, preferably, are licensed by the corresponding authorities to serve as professional real estate agents.

To further enable the objective character of facility management's real estate personnel, facility management 32 preferably also has rights to a license for providing or hiring agents to provide some or all of the real estate services to clients. As such, even though the corresponding real estate transaction may generate commissions, any such commissions are accrued primarily by the facility management business 32 rather than the specialists 30, 31 providing the help for the clients.

An important aspect of many variations of the inventions is that relocation specialists are objective. Although not necessarily in every embodiment of every variation of the inventions, this objective character is preferably achieved by facility management 32 providing real estate service personnel in a way that ensures such personnel are objective in providing such service, preferably by providing them without paying them differently if the client chooses one real estate property as opposed to another property. To accomplish as much, the real estate personnel are preferably salaried and paid on a non-commission basis. In the illustrated preferred embodiments, all of the personal relocation specialists 30 (or, in alternative variations, some of those specialists 30) also serve the roles of the real estate personnel, and vice versa. Accordingly, relocation specialists 30 preferably meet most if not all the requirements of licensed real estate agents and, preferably, are licensed by the corresponding authorities to serve as professional real estate agents.

Hence, whether a client purchases a home or rents an apartment, the relocation specialist 30 is not paid any differently for their work in assisting the transaction. Rather, any corresponding commission goes primarily if not completely to facility management 32, to help offset business losses caused by the provision of other services that do not generate as much revenue for comparable effort. Occasionally, facility management 32 may provide both the buyer's agent and the seller's listing, assuming there is not a conflict of interest or that the client waives any such conflict of interest.

The housing options available include single family homes to purchase or rent as well as multi-family options. The personal relocation specialists help clients figure out the family's needs and arrange for them to meet with the proper representative on site. Once the housing choice is made and a location is selected, they can then select and order the other services they would like to have. Everyone renting or owning is directed through contracting for water, electricity, cable, security, telephone, insurance and other services. In addition, a Title Company is located at or adjacent to the core facility 100 so those closing on new homes will be able to come back to a familiar location.

### Particular Business Methods

Preferred embodiments include not only the facility 100 and the operation of that facility 100, but also include the marketing of facility 100 through a multi-pronged approach. The first prong is to reach out to the various noncommissioned officer and officer groups on each of the bases in the military community. When a service member 5 moves to a new unit, he or she is assigned a sponsor 9. A sponsor is a service member associated with the gaining station of military base 80 who must by regulation take care of the newcomer. The sponsor 9 is required to meet, greet and integrate the newcomer service member 5 into the newly-assigned military unit. If requested by the newcomer 5, the sponsor 9 might be asked to help them find a new home or other services in the communities 90 near the new military base 80.

Another prong involves meeting with senior military members, both locally and nationally, and congressmen, introducing them to the services that are being provided, and reaching out to potential sponsors and introducing them to the relocation center 100 and the related systems and methods. Additional prongs include helping to register new clients 5 who are referred by their sponsors 9. With these and other grassroots marketing efforts, the preferred embodiment of facility 100 is introduced to those service members 5 who are coming to the military community.

The preferred relocation process of the present inventions can be initiated by the relocating personnel themselves or by the sponsor. In either case the sponsor or the client is enrolled in the relocation program. This enrollment (or registration) can be conducted by phone, Internet, or in person. In future alternative embodiments, enrollment will be initiated automatically by a computer interface with the Department of Defense or other organization that tracks pertinent military orders such that, when a pertinent military relocation order is issued by the military, the client is automatically enrolled or is automatically prompted to enroll. After enrollment in the data management system 192, the system prompts for assignment of a personal relocation specialist 30 and generates a customized checklist which is used to drive the relocation process. The personal relocation specialist 30 assists in the timely collection of pertinent data and the timely start of the service provider interface process. Furthermore, at enrollment, the data processing system 192 checks available data to ensure that the relocating personnel 5 is qualified and authorized to use the data processing system 192 and generates a notification of any potential alerts or errors in the data.

Each gaining end services provider (a “Licensee”) in the Location enters into a License Agreement with the overall system, prohibiting them from participating in similar concepts so long as they maintain a contractual relationship with the company and remain in good standing. Licensees are authorized to offer specific product(s) and/or service(s) and for no other purpose. In addition to the local License Agreement, national companies enter into a Master License Agreement with a national system, granting a Master Licensee the right to participate in future markets so long as quality requirements remain adequately satisfied.

Each facility 100 is staffed with objective specialists, preferably employed by management 32. Management 32 includes a Manager and Assistant Manager who are charged with operating each individual facility 100 and scheduling the lead specialists 31 and the personal relocation specialists 30, and themselves, to handle the work load for operating facility 100. On a typically busy workday, there are roughly seven system-based associates 30, 31 in the client space 110 and, preferably, several more representatives 33 from community-based service providers. Facility 100 preferably has adequate staff to be open for client visits at least six days per week. The typical staff makeup of system-level associates at each facility 100 location is one manager representative 32, one assistant manager (not shown separately), one or two lead specialists 31, and from four to seven personal relocation specialists 30. Each location can service, on average, twelve to fifteen clients per day. As monthly volume surpasses three hundred clients for a facility 100, additional personal relocation specialists 30 will be added. One or more of the embodiments also use due diligence in finding and hiring new associates, ideally those who have served in the military and have experienced military moves themselves.

Once a client 5 has completed his or her move, a final questionnaire is completed to help the system-based management 32 analyze the experience, make corrections and better serve future clients 5.

For an even more detailed understanding of one preferred embodiment at the time of filing this present patent application, some aspects of the actual commercial variation of the San Antonio embodiment can be observed in the Fort Sam Center located at the corner of Rittiman Road and Harry Wurzbach Boulevard just north of Fort Sam Houston in San Antonio, Tex. This San Antonio embodiment is an illustrative example of the core facility 100 for one preferred embodiment. The San Antonio embodiment serves as a facility 100 for providing a system and method according to the teachings of the invention. It is in a prime location easily accessible not only to Fort Sam Houston, but also to downtown San Antonio and the San Antonio International Airport. It is also conveniently located ten blocks or less from Interstate Highway 35 (also Loop 410), a main highway in San Antonio. FIG. 3 shows an approximate floor plan for the San Antonio embodiment. Other preferred embodiments can use facilities with similar or analogous floor plans, although many adjustments, variations and substitutions can be made while still falling within the scope of the inventions as claimed.

As will be understood by those of skill in business planning, the cost to complete such a facility 100 can be factored into an overall business plan. For any particular core facility 100 embodiments, the method preferably involves investing less than $1 Million per hub facility 100, while renting to gaining end service providers at market rates.

Many embodiments provide a free service to clients 5 and do not cost anything to the Department of Defense. Instead, such embodiments derive revenue from the rental of space in the facility 100 and from transactions arranged for clients 5 and from service providers that are available to clients at the facility 100. Preferably, such revenue accrues in the form of commissions, rental fees, referral fees, and license fees. Management 32 collects such revenues and uses them to pay operating expenses for facility 100 and salaries and other overhead for the management representatives 32 and the specialists 30, 31.

Although alternative embodiments can employ a facility of much smaller (or larger) size, a preferred embodiment of facility 100 is approximately 6500 square feet in total size, and most of that floor space is dedicated to conference areas 30, 60.

Preferably, in order to operate facility 100 at no cost to each client 5 and at no (or little) cost to the DoD, each facility 100 includes at least a dozen spaces 130, 160 that generate revenue when properties or services are acquired by clients 5 through those spaces 130, 160. Preferably, all of such spaces 130, 160 are rented to the community-based service providers according to a license and/or rental agreement entered into between the facility 100 and the corresponding service provider. Some of those spaces, such as spaces 160a-h, are customized with information and representative access for a particular service provider. Other ones of the spaces, such as multifunction spaces 130a-h, are shared spaces where rental and marketing fees still accrue for providers that are featured through the multi-function interactive displays 134, 135 accessible in those spaces. The number of rental units used by each provider will vary with the services they are offering.

For instance, an insurance provider's space in one preferred embodiment occupies two rental units 130d, 130e; whereas a cable company only has one unit 160f, and one of the local auto dealers might have only one unit 160b. The rental rates preferably range from no cost per unit to a flat fee for a rental unit. Each agreement is individually negotiated and can vary based on what the provider is providing. A provider may wish to pay transaction fees in lieu of rent or some combination of both. When a service provider has a national presence, the contracts will be negotiated on a national basis, and they will be present in all locations.

A bigger source of revenue for the overall operation of facility 100 accrues in the form of commissions and fees generated by the sales of services, including from the purchase or rental of a home or apartment. These commissions and other fees are collected once a client 5 has selected a place to live and the service is contracted and provided. Such fees can vary by location, but commissions and referral fees are collected for the account of the overall facility 100 each time a client 5 purchases or rents a home or apartment. The commissions earned by facility 100 for purchasing a home are based principally on a percentage of the sales price, and commissions earned for rentals are based principally on a percentage of the rent. Marketing fees are also earned for certain services, often on a flat fee or hybrid basis. With clients 5 that utilize an apartment location service offered through facility 100 and rent an apartment, one or more of the preferred embodiments will earn a fixed marketing fee per apartment rented and a separate fee for each home rented. Preferably, the apartment locating service accessible in each multifunction space 130a-h is of the “smart locating” type. Again, the fees earned by facility 100 vary by provider and/or service, but any individual type of fee does not make up a substantial part of the revenue to support operations at the facility 100 of one or more of the preferred embodiments.

Facility 100 and the related operations are preferably adapted to serve approximately 5,000 clients per year. Preferred variations of facility 100 preferably each have a dozen or two provider areas 30a-30p that service providers can rent either under continuous dedicated rental or under an as-used rental plan. In some embodiments, some providers (preferably those asterisked in the list of a typical provider array below) do not pay rental fees, sometimes as a preferential arrangement, but often in exchange for higher package or marketing fees.

Preferably, the present invention helps ensure that the relocation specialists are relatively unbiased. Preferred embodiments achieve unbiased relocation guidance from the relocation specialists by compensating those specialists at substantially the same level (i.e., with no variation or, alternatively, with relatively little variation) irrespective of whether a client makes a decision to obtain a particular service, irrespective of what level of service the client chooses to obtain, and irrespective of which service provider is utilized to provide that service. For terminology purposes, we refer to such a compensation arrangement as being “unbiased” or “objective.” For preferred embodiments in which the relocation specialists receive exactly the same compensation irrespective of the factors outlined above, we refer to the compensation and the personnel as being “completely unbiased” or “completely objective.”

Despite the receipt of commissions or marketing fees by the overall operation, many preferred embodiments achieve completely unbiased specialists in accord with the present invention by setting specialist compensation in a manner that is not based on commissions or marketing fees in any respect. Granted, there may still be some indirect impact from commissions or marketing fees while still being completely objective. Particularly, it is recognized that facility management 32 may discuss revenues and may make end-of-year bonus and raise determinations based on overall revenues including commissions and marketing fees. However, by minimizing the impact of marketing fees or commissions on a specialist's regular compensation during the year, unbiased compensation arrangements help maximize a relocation specialist's objectivity.

One source of commissions accrued to the operation of facility 100, for instance, is received from real estate transactions consummated, which preferably goes completely to the overall operation of facility 100 without any portion going to the relocation specialists 30. In alternative embodiments that use objective relocation specialists (in contrast to completely objective relocation specialists), less than a third of the marketing fee or commissions may be shared with the relocation specialists, which results in a bias that is relatively less than experienced in the respective service industries as a whole.

One example of marketing fees accrued to the operation of facility 100 in preferred embodiments is received from the banking service providers that are available for consult through the facility 100. More particularly, banking industry representatives preferably pay marketing fees based on the number of new bank accounts opened and/or the corresponding dollar amount deposited through clients that are introduced to the provider through the facility 100. Although specialists 30, 31 are preferably kept completely objective, preset fees will also accrue to the overall operation of facility 100 for cable and security packages sold to those clients 5 who purchase or rent a place to live. These and other marketing fees are preferably earned to the account of the overall facility 100 from different sources as well, even though the specialists 30, 31 preferably do not directly receive any portion of such marketing fees, in order to ensure objectivity of such specialists 30, 31. Preferred embodiments also earn preset and/or sliding scale fees for each client 5 who is not an existing customer and opens an account with one or more of the community-based service providers that are accessible through facility 100 while, again, still ensuring objectivity of the specialists 30, 31. One or more of the preferred embodiments also earn commissions and fees for clients 5 who rent or purchase homes or apartments, in amounts that are typical in the real estate industry.

As well, alternative embodiments to the various components, subsystems and processes described herein may come in any known form and may also be implemented by hardware, software, scripting languages, firmware, middleware, microcode, hardware description languages, or the like, and/or any combination thereof. When implemented with coded programming, it should also be understood that the program code or code segments to perform the necessary steps or tasks of alternative embodiments may be coded in solid state or may be stored in a machine-readable medium such as a computer storage medium. A code segment or machine-executable step or instruction may represent a procedure, a function, a subprogram, a program, a routine, a subroutine, a module, a software package, a script, a class, or any combination of instructions, data structures, and/or program statements or the like. Executable code segments may also be coupled to other code segments or to a hardware circuit by passing and/or receiving information, data, arguments, parameters, and/or memory contents or the like, which may be passed, forwarded, or transmitted via any suitable means including memory sharing, message passing, token passing, network transmission, etc.

While not presently preferred, other alternative embodiments may make provisions for moving and storage services, home building services, Chamber of Commerce, convention and visitors bureau, child care services, medical services, or any others that may be of interest in a particular context. Another embodiment offers a program for the military spouses and family members to help soldiers returning from combat to assimilate into “peaceful” life away from combat while also counseling family members on how to survive the returning process. Additionally, some alternative embodiments may be adapted in the data management system 192 to give automatic updates and reminders to the client 5 and sponsor 9 at various times prior to and after a relocation.

Whether now known or later discovered, there are countless other alternatives, variations and modifications of the many features of the various described and illustrated embodiments, both in construction and in operation, that will be evident to those of skill in the art after careful and discerning review of the foregoing descriptions, particularly if they are also able to review all of the various systems and methods that have been tried in the public domain or otherwise described in the prior art. All such alternatives, variations and modifications are contemplated to fall within the scope of the present invention.

In all respects, it should also be understood that the drawings and detailed descriptions of numerous embodiments herein are provided by way of example only and are to be regarded in an illustrative rather than in a restrictive manner. Such drawings and descriptions of the examples are not intended to limit the systems and methods of the present invention. Rather, the present invention includes all articles, systems and processes within the scope and spirit of the invention as claimed, as the claims may be amended, replaced or otherwise modified during the course of related prosecution. Any current, amended, or added claims should be interpreted to embrace all further modifications, changes, rearrangements, substitutions, alternatives, design choices, and embodiments that may be evident to those of skill in the art, whether now known or later discovered. In any case, all substantially equivalent variations should be considered within the scope of the invention and, absent express indication otherwise, all structural or functional equivalents are anticipated to remain within the spirit and scope of the disclosed system and method.

I claim:

1. A system to help military personnel who are subject to military relocation orders, such military relocation orders requiring a member of the military to change station from a station of origin to a gaining station associated with a military base within a military community that includes both the military base and neighboring civilian communities, said system comprising:
a) a physical facility including a plurality of distinct personnel spaces for said military member or his or her representative to meet or otherwise confer with specialists who are knowledgeable about how to help military personnel arrange for services from providers operating in the neighboring civilian communities, said physical facility being operated by or under the management of a business enterprise;
b) a computerized data management system including at least one user terminal for accessing and modifying data stored in a computer database, said at least one user terminal being located within said physical facility, and said computerized data management system being adapted to allow said military member to review data presentations based on aspects of said computer database from a remote location through the Internet or another independent data communication network;
c) said plurality of distinct personnel spaces including at least a first space adapted with interactive displays and seating furniture for said military member or his or her representative to view interactive information about available residential properties in the neighboring civilian communities and to meet personally with a personal relocation specialist who is knowledgeable about how to review and discuss real estate alternatives in the neighboring civilian communities;
d) said plurality of distinct personnel spaces also including a plurality of conference areas adapted with interactive displays and seating furniture for said military member or his or her representative to view interactive information and to meet or otherwise confer with representatives of independent providers of services in the neighboring civilian communities, said independent providers being operated under management that is independent of said business enterprise; and
e) said physical facility being located either (i) within geographical perimeters of the military base of said gaining station, or (ii) within a five-mile driving distance outside said geographical perimeters.

2. The system of claim 1, wherein said first space comprises interactive map displays for displaying information about available real estate alternatives within said military community.

3. The system of claim 1, wherein said first space further comprises a real estate services provider consultation area for allowing said military member to communicate with a licensed real estate services representative who is paid without direct regard to whether said military member chooses to buy or rent real estate through operations at said physical facility.

4. The system of claim 1, wherein:
a) said personal relocation specialist is completely objective; and
b) said first space includes a reception area for allowing said military member to communicate with a completely objective specialist.

5. The system of claim 1, wherein:
a) said plurality of conference areas includes a first conference area and a second conference area; and
b) said second conference area is adapted with seating furniture and other accommodations for allowing said military member or his or her representative to communicate with a representative of an independent service provider that provides or makes available at least one of the following types of services: (i) banking services; (ii) automobile sales or automobile leasing services; (iii) home security services; (iv) electric utility services; (v) natural gas utility services; (vi) water services; (vii) sewer services; (viii) internet access services; (ix) LAN-line telephone services; (x) cellular telephone services; (xi) home insurance services; (xii) renter's insurance services; (xiii) employment services; (xiv) education services; (xv) entertainment services; and (xvi) real estate services.

6. The system of claim 4, wherein at least one of said second, third and fourth spaces is adapted with interactive communication equipment for direct interactive communication with a representative of an independent service provider.

7. The system of claim 5, wherein said interactive communication equipment includes both video display and audio communication equipment, for enabling said military member to both see and here information communicated from an independent service provider that is not personally present at said physical facility.

8. The system of claim 1 wherein said business enterprise compensates said relocation specialist in a manner to encourage objectivity.

9. The system of claim 7, wherein said relocation specialists is compensated by said business enterprise without regard to commissions or marketing fees accrued from any resulting transactions between said military member and said service provider.

10. The system of claim 7 wherein said real estate services consultation area is adapted with a first real estate information access and a second real estate information access.

11. The system of claim 1 wherein:
a) said first space includes a first real estate information access and a second real estate information access;
b) said first real estate information access is particularly adapted for enabling access to information about homes available for purchase in the area on and/or around said receiving military base; and
c) said second real estate information access is particularly adapted for enabling access to information about rental availabilities in the area on and/or around said receiving military base.

12. The system of claim 1 wherein at least one of said plurality of personnel spaces comprises:
a) displays for graphic and/or print materials for providing information about the relocation services available from a first specific service provider, said materials promoting the services of said first service provider that are available to help military personnel relocate to the receiving military base;
b) seating furniture and a work surface for conferring with a direct representative of said first service provider either through communications equipment or face-to-face when such a direct representative is available at said physical facility; and
c) interactive communication equipment for direct interactive communication with a representative of a relocation service provider when such representative is not present at said facility.

13. The system of claim 14 wherein said second, third and fourth of said plurality of consultation areas are adapted with adaptations that serve functions that are comparable to the functions of said adaptations of said at least one consultation area, except that the adaptations of said second, third and fourth consultation areas relate to a second, third and fourth specific service provider, respectively.

14. The system of claim 15 wherein one of said second, third and fourth specific service providers uniquely offers banking services, and an other of said second, third and fourth service providers uniquely offers title insurance services for relocating military personnel.

15. The system of claim 16 wherein:
a) said reception area has a first exterior entrance to said facility; and
b) one said plurality of spaces that is for said service provider that uniquely offers title insurance services has a second exterior entrance to said facility, said second exterior facility entrance being in a different room than said first exterior entrance.

16. The system of claim 17 wherein said physical facility is further adapted to allow trained and objective staff personnel to meet separately with relocating military personnel, to counsel them on their options and likely needs and to introduce them to said direct representatives as appropriate in order to meet their relocation needs, said staff personnel being characterized as “objective” in that they are not paid commissions or the like by said first, second, third or fourth service providers.

17. The system of claim 1 wherein said second, third and fourth of said plurality of consultation areas are adapted with adaptations that serve functions that are comparable to the functions of said adaptations of said at least one consultation area, except that the adaptations of said second, third and fourth consultation areas relate to a second, third and fourth specific service provider, respectively.

18. A business method for providing military personnel relocation services, said business method comprising the steps of:
a) selecting a number of community-based service providers of industries and services of interest to relocating military personnel on the gaining end of a military relocation;
b) providing a facility for providing relocation services, said facility including an area where said relocating military personnel can confer with a specialist for learning about said number of community-based service providers; and
c) operating an enterprise at said facility, said enterprise providing said specialist in a manner such that said specialist is completely objective about whether said military personnel acquire services through said number of community-based service providers.

19. The business method of claim 18, wherein said facility includes a number of conference spaces corresponding to said number of community-based service providers, said conference spaces being adapted for enabling conference with representatives of said community-based service providers.

20. The business method of claim 19, further comprising the steps of:
a) training said specialist to know about each of said number of community-based service providers; and
b) ensuring that said specialist is licensed to market and sell real estate properties in the community surrounding a military base on the gaining end of said military relocation.
